(19) United States
(12) Patent Application Publication
(10) Pub. No.: US 2017/0272758 A1
(43) Pub. Date: Sep. 21, 2017

(54) VIDEO ENCODING METHOD AND APPARATUS USING INDEPENDENT PARTITION CODING AND ASSOCIATED VIDEO DECODING METHOD AND APPARATUS

(71) Applicant: MEDIATEK INC., Hsin-Chu (TW)

(72) Inventors: Hung-Chih Lin, Nantou County (TW); Shen-Kai Chang, Hsinchu County (TW); Ka-Hang Lok, Hsinchu City (TW); Lu-Chia Tseng, Hsinchu City (TW)

(21) Appl. No.: 15/459,004

(22) Filed: Mar. 15, 2017

Related U.S. Application Data
(60) Provisional application No. 62/308,992, filed on Mar. 16, 2016.

(51) Int. Cl. H04N 19/159; H04N 19/184; H04N 19/182; H04N 19/117; H04N 19/176; H04N 19/172

(52) U.S. Cl. CPC H04N 19/159; H04N 19/176; H04N 19/172; H04N 19/182; H04N 19/117; H04N 19/184

(57) ABSTRACT

A method of encoding a frame to generate an output bitstream has following steps: dividing the frame into partitions; dividing each of the partitions into blocks, wherein each of the blocks is composed of pixels; assigning a first segmentation identifier to each of first blocks located at partition boundaries each between two adjacent partitions within the frame, wherein the first blocks belong to a first segment, and the first segmentation identifier is signaled per first block; and encoding each of the blocks. The step of encoding each of the blocks includes: generating reconstructed blocks for the blocks, respectively; and configuring an in-loop filter by a predetermined in-loop filtering setting in response to the first segmentation identifier, wherein the in-loop filter with the predetermined in-loop filtering setting does not apply in-loop filtering to each reconstructed block corresponding to the first segment.

### CROSS REFERENCE TO RELATED APPLICATIONS

This application claims the benefit of U.S. provisional application No. 62/308,992, filed on Mar. 16, 2016 and incorporated herein by reference.

### BACKGROUND

The present invention relates to video encoding and video decoding, and more particularly, to video encoding method and apparatus using independent partition coding and associated video decoding method and apparatus.

The conventional video coding standards generally adopt a block based coding technique to exploit spatial and temporal redundancy. For example, the basic approach is to divide the whole source frame into a plurality of blocks, perform intra prediction/inter prediction on each block, transform residues of each block, and perform quantization and entropy encoding. Besides, a reconstructed frame is generated to provide reference pixel data used for coding following blocks. For certain video coding standards, in-loop filter(s) maybe used for enhancing the image quality of the reconstructed frame. A video decoder is used to perform an inverse operation of a video encoding operation performed by a video encoder. For example, a reconstructed frame is generated in the video decoder to provide reference pixel data used for decoding following blocks.

The in-loop filtering of a current block may require data provided from neighbor block(s). As a result, concerning the in-loop filtering, there is data dependency between adjacent blocks. In a case where the adjacent blocks belong to different partitions (e.g., slices or tiles) within a same frame, parallel/independent encoding of multiple partitions and parallel/independent decoding of multiple partitions cannot be achieved due to data dependency of the in-loop filtering. Hence, there is a need for an innovative in-loop filtering design which allows parallel/independent encoding of different partitions and parallel/independent decoding of different partitions.

### SUMMARY

One of the objectives of the claimed invention is to provide video encoding method and apparatus using independent partition coding and associated video decoding method and apparatus.

According to a first aspect of the present invention, an exemplary method of encoding a frame to generate an output bitstream is provided. The exemplary method includes: dividing the frame into partitions; dividing each of the partitions into blocks, wherein each of the blocks is composed of pixels; assigning a first segmentation identifier to each of first blocks located at partition boundaries each between two adjacent partitions within the frame, wherein the first blocks belong to a first segment, and the first segmentation identifier is signaled via the output bitstream per first block; and encoding each of the blocks. The step of encoding each of the blocks includes: generating reconstructed blocks for the blocks, respectively; and configuring an in-loop filter by a predetermined in-loop filtering setting in response to the first segmentation identifier, wherein the in-loop filter with the predetermined in-loop filtering setting does not apply in-loop filtering to each reconstructed block corresponding to the first segment.

According to a second aspect of the present invention, an exemplary method of decoding an input bitstream generated from encoding a frame is disclosed. The frame is divided into partitions, each of the partitions is divided into blocks, and each of the blocks is composed of pixels. The exemplary method includes decoding each of blocks within a selected partition of the frame. The step of decoding each of blocks within a selected partition of the frame includes: generating a reconstructed block for the block; deriving a segmentation identifier of the block from the input bitstream; and when the segmentation identifier is a first segmentation identifier, configuring an in-loop filter by a predetermined in-loop filtering setting in response to the first segmentation identifier, wherein the in-loop filter with the predetermined in-loop filtering setting does not apply in-loop filtering to the reconstructed block belonging to a first segment, and the first segment comprises first blocks located at partition boundaries each between two adjacent partitions within the frame.

According to a third aspect of the present invention, an exemplary video encoder for encoding a frame to generate an output bitstream is disclosed. The exemplary video encoder includes a control circuit and an encoding circuit. The control circuit is arranged to divide the frame into partitions, divide each of the partitions into blocks each being composed of pixels, and assign a first segmentation identifier to each of first blocks located at partition boundaries each between two adjacent partitions within the frame, wherein the first blocks belong to a first segment, and the first segmentation identifier is signaled via the output bitstream per first block. The encoding circuit is arranged to encode each of the blocks, and includes a reconstruction circuit and an in-loop filter. The reconstruction circuit is arranged to generate reconstructed blocks for the blocks, respectively. The in-loop filter is arranged to employ a predetermined in-loop filtering setting in response to the first segmentation identifier, wherein the in-loop filter with the predetermined in-loop filtering setting does not apply in-loop filtering to each reconstructed block corresponding to the first segment.

According to a fourth aspect of the present invention, an exemplary video decoder for decoding an input bitstream generated from encoding a frame is disclosed. The frame is divided into partitions, each of the partitions is divided into blocks, and each of the blocks is composed of pixels. The exemplary video decoder includes a decoding circuit arranged to decode each of blocks within a selected partition of the frame. The decoding circuit includes a reconstruction circuit, an entropy decoding circuit, and an in-loop filter. The reconstruction circuit is arranged to generate a reconstructed block for the block. The entropy decoding circuit is arranged to derive a segmentation identifier of the block from the input bitstream. When the segmentation identifier is a first segmentation identifier, the in-loop filter is arranged to employ a predetermined in-loop filtering setting in response to the first segmentation identifier, wherein the in-loop filter with the predetermined in-loop filtering setting does not apply in-loop filtering to the reconstructed block belonging to a first segment, and the first segment comprises first blocks located at partition boundaries each between two adjacent partitions within the frame.

According to a fifth aspect of the present invention, an exemplary in-loop filtering method for a frame is disclosed. The frame is divided into partitions, each of the partitions is divided into blocks, and each of the blocks is composed of pixels. The in-loop filtering method includes: receiving a reconstructed block; and when the reconstructed block is any of first blocks located at partition boundaries each between two adjacent partitions within the frame, blocking an in-loop filter from applying in-loop filtering to the reconstructed block, wherein the frame has a 360VR cubic format and is composed of cubic faces, and the partition boundaries comprise cubic face boundaries each between two adjacent cubic faces.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video processing system according to an embodiment of the present invention.

FIG. 2 is a diagram illustrating a video encoder according to an embodiment of the present invention.

FIG. 3 is a diagram illustrating a video decoder according to an embodiment of the present invention.

FIG. 4 is a diagram illustrating an independent partition coding design according to an embodiment of the present invention.

FIG. 5 is a diagram illustrating a result of segmenting a frame into a first segment and a second segment under an unconstrained mode decision according to an embodiment of the present invention.

FIG. 6 is a diagram illustrating a result of segmenting a frame into a first segment and a second segment under a constrained mode decision according to an embodiment of the present invention.

FIG. 7 is a diagram illustrating a frame that has a 360VR assembled cubic format and is composed of independently decodable partitions according to an embodiment of the present invention.

FIG. 8 is a diagram illustrating a cubic assembler design according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

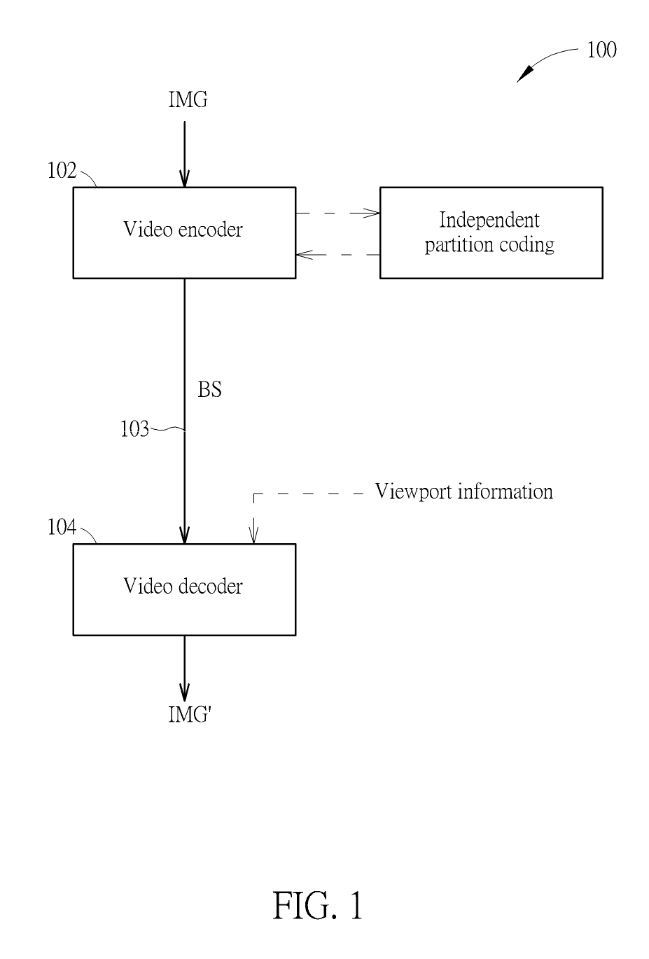

FIG. 1 is a diagram illustrating a video processing system according to an embodiment of the present invention. The video processing system 100 includes a video encoder 102 and a video decoder 104, where the video encoder 102 communicates with the video decoder 104 via a transmission means 103. For example, the transmission means 103 may be a wired/wireless communication link or a storage medium. In this embodiment, the video encoder 102 is arranged to encode a frame IMG to generate a bitstream BS as an output bitstream, and the video decoder 104 is arranged to receive the bitstream BS as an input bitstream and decode the received bitstream BS to generate a decoded frame IMG′. For example, the frame IMG may be generated from a video capture device, and the decoded frame IMG′ may be displayed on a display screen.

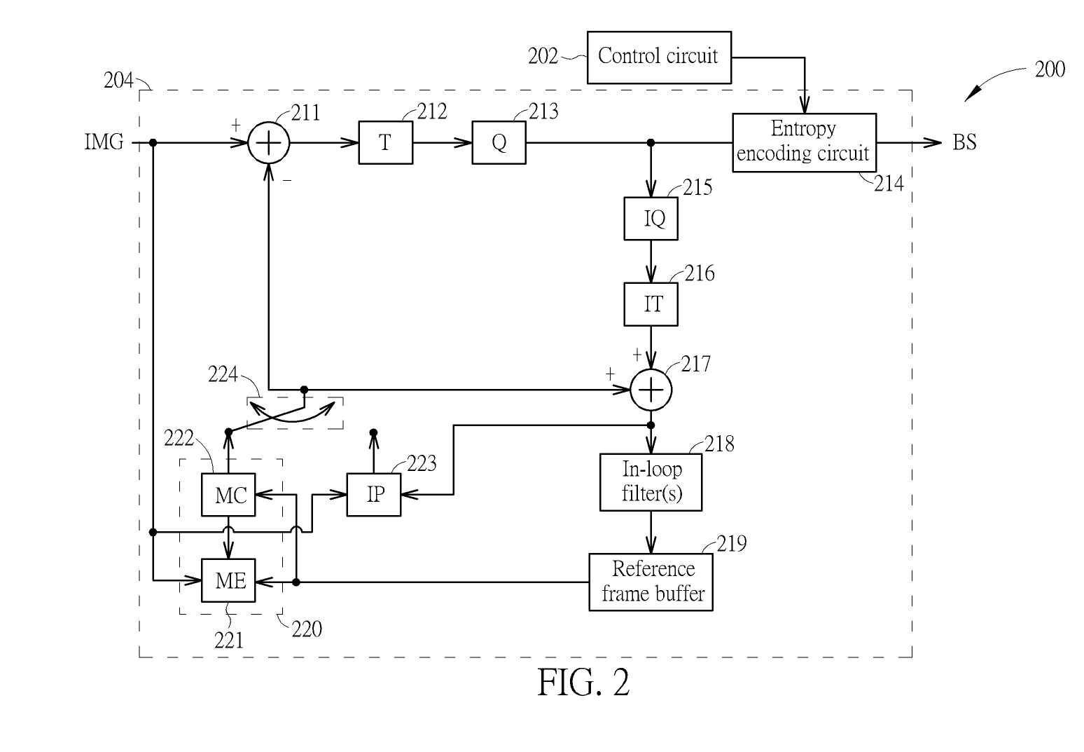

FIG. 2 is a diagram illustrating a video encoder according to an embodiment of the present invention. For example, the video encoder 102 shown in FIG. 1 may be implemented using the video encoder 200 shown in FIG. 2. It should be noted that the video encoder architecture shown in FIG. 2 is for illustrative purposes only, and is not meant to be a limitation of the present invention. As shown in FIG. 2, the video encoder 200 includes a control circuit 202 and an encoding circuit 204. The control circuit 202 provides encoder control over processing blocks of the encoding circuit 204. For example, the control circuit 202 may decide the encoding parameters (e.g., control syntax elements) for the encoding circuit 204, where the encoding parameters (e.g., control syntax elements) are signaled to a video decoder (e.g., video decoder 104 shown in FIG. 1) via the bitstream BS generated from the video encoder 200. Concerning the encoding circuit 204, it includes an adder 211 (which is used to perform data subtraction), a transform circuit (denoted by “T”) 212, a quantization circuit (denoted by “Q”) 213, an entropy encoding circuit (e.g., a variable length encoder) 214, an inverse quantization circuit (denoted by “IQ”) 215, an inverse transform circuit (denoted by “IT”) 216, an adder (which is used to perform data summation) 217, at least one in-loop filter (e.g., a deblocking filter) 218, a reference frame buffer 219, an inter prediction circuit 220 (which includes a motion estimation circuit (denoted by “ME”) 221 and a motion compensation circuit (denoted by “MC”) 222), an intra prediction circuit (denoted by “IP”) 223, and an intra/inter mode selection switch 224. The adder 211 is a residual calculation circuit for subtracting a predicted block from a current block to be encoded to generate residual of the current block to the transform circuit 212. The predicted block may be generated from the intra prediction circuit 223 when the intra/inter mode selection switch 224 is controlled by an intra prediction mode selected, and may be generated from the inter prediction circuit 220 when the intra/inter mode selection switch 224 is controlled by an inter prediction mode selected. After being sequentially processed by the transform circuit 212 and the quantization circuit 213, the residual of the current block is converted into quantized transform coefficients, where the quantized transform coefficients are entropy encoded at the entropy encoding circuit 214 to be a part of the bitstream BS.

The encoding circuit 204 has an internal decoding circuit. Hence, the quantized transform coefficients are sequentially processed via the inverse quantization circuit 215 and the inverse transform circuit 216 to generate decoded residual of the current block to the adder 217. The adder 217 acts as a reconstruction circuit that combines the decoded residual of the current block and the predicted block of the current block to generate a reconstructed block of a reference frame (which is a reconstructed frame) stored in the reference frame buffer 219. The inter prediction circuit 220 may use one or more reference frames in the reference frame buffer 219 to generate the predicted block under inter prediction. Before the reconstructed block is stored into the reference frame buffer 219, the in-loop filter(s) 218 may perform designated in-loop filtering upon the reconstructed block. For example, the in-loop filter(s) 218 may include a deblocking filter intended to reduce the blocking artifacts introduced due to block-based coding.

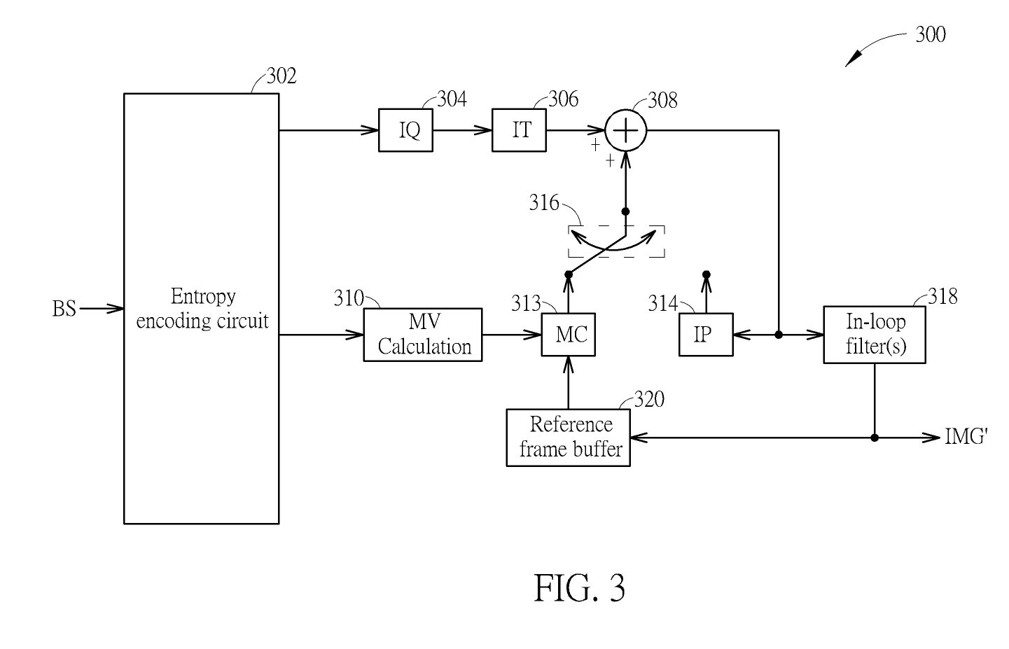

FIG. 3 is a diagram illustrating a video decoder according to an embodiment of the present invention. For example, the video decoder 104 shown in FIG. 1 may be implemented using the video decoder 300 shown in FIG. 3. It should be noted that the video decoder architecture shown in FIG. 3 is for illustrative purposes only, and is not meant to be a limitation of the present invention. As shown in FIG. 3, the video decoder 300 is a decoding circuit that includes an entropy decoding circuit (e.g., a variable length decoder) 302, an inverse quantization circuit (denoted by “IQ”) 304, an inverse transform circuit (denoted by “IT”) 306, an adder (which is used to act as a reconstruction circuit that performs data summation) 308, a motion vector calculation circuit (denoted by “MV calculation”) 310, a motion compensation circuit (denoted by “MC”) 312, an intra prediction circuit (denoted by “IP”) 314, an intra/inter mode selection switch 316, at least one in-loop filter (e.g., a deblocking filter) 318, and a reference frame buffer 320.

When a block is inter-coded, the motion vector calculation circuit 112 refers to information parsed from the bitstream BS by the entropy decoding circuit 302 to determine a motion vector between a current block of the frame being decoded and a predicted block of a reference frame that is a reconstructed frame and stored in the reference frame buffer 320. The motion compensation circuit 313 may perform interpolation filtering to generate the predicted block according to the motion vector. The predicted block is supplied to the intra/inter mode selection switch 316. Since the block is inter-coded, the intra/inter mode selection switch 316 outputs the predicted block generated from the motion compensation circuit 313 to the adder 308 that serves as a reconstruction circuit.

When a block is intra-coded, the intra prediction circuit 314 generates the predicted block to the intra/inter mode selection switch 316. Since the block is intra-coded, the intra/inter mode selection switch 316 outputs the predicted block generated from the intra prediction circuit 314 to the adder 308 that serves as a reconstruction circuit.

In addition, decoded residual of the block is obtained through the entropy decoding circuit 302, the inverse quantization circuit 304, and the inverse transform circuit 306. The reconstruction circuit (i.e., adder 308) combines the decoded residual and the predicted block to generate a reconstructed block. The reconstructed block may be stored into the reference frame buffer 320 to be apart of a reference frame (which is a reconstructed frame) that may be used for decoding following blocks and frames. Similarly, before the reconstructed block is stored into the reference frame buffer 320, the in-loop filter(s) 318 may perform designated in-loop filtering upon the reconstructed block. For example, the in-loop filter(s) 318 may include a deblocking filter intended to reduce the blocking artifacts introduced due to block-based coding.

For clarity and simplicity, it is assumed that the in-loop filter 218 implemented in the video encoder 102/200 and the in-loop filter 318 implemented in the video decoder 104/300 are deblocking filters. In other words, the terms “in-loop filter” and “deblocking filter” maybe interchangeable in the present invention. However, this is not meant to be a limitation of the present invention. In practice, the same independent partition coding design proposed by the present invention may also be applied to other in-loop filters, such as SAO (sample adaptive offset), ALF (adaptive loop filter), dering filter, and CLPF (constrained low-pass filter). These alternative designs all fall within the scope of the present invention.

The deblocking filter is applied to reconstructed samples before writing them into the reference frame buffer in the video encoder/video decoder. For example, the deblocking filter is applied to all reconstructed samples at a boundary of each transform block except the case where the boundary is also a frame boundary. For example, concerning a transform block, the deblocking filter is applied to all reconstructed samples at a left vertical edge (i.e., left boundary) of the transform block when the left vertical edge is not a left vertical edge (i.e., left boundary) of a frame, and is also applied to all reconstructed samples at a top horizontal edge (i.e., top boundary) of the transform block when the top horizontal edge is not a top horizontal edge (i.e., top boundary) of the frame. To filter reconstructed samples at the left vertical edge (i.e., left boundary) of the transform block, the deblocking filter requires reconstructed samples on both sides of the left vertical edge. Hence, reconstructed samples belonging to the transform block and reconstructed samples belonging to left neighbor transform block(s) are needed by vertical edge filtering of the deblocking filter. Similarly, to filter reconstructed samples at the top horizontal edge (i.e., top boundary) of the transform block, the deblocking filter requires reconstructed samples on both sides of the top horizontal edge. Hence, reconstructed samples belonging to the transform block and reconstructed samples belonging to upper neighbor transform block(s) are needed by horizontal edge filtering of the deblocking filter. One coding block may be divided into one or more transform blocks, depending upon the transform size(s) used. Hence, a left vertical edge (i.e., left boundary) of the coding block is aligned with left vertical edge(s) of transform block(s) included in the coding block, and a top horizontal edge (i.e., top boundary) of the coding block is aligned with top vertical edge(s) of transform block(s) included in the coding block. Hence, concerning deblocking filtering of a coding block, there is data dependency between the coding block and adjacent coding block(s). If the coding block is located at a partition boundary between two adjacent partitions (e.g., adjacent slices or adjacent tiles) within a frame, data dependency of the deblocking filtering may degrade the parallel processing performance of multiple partitions within the same frame.

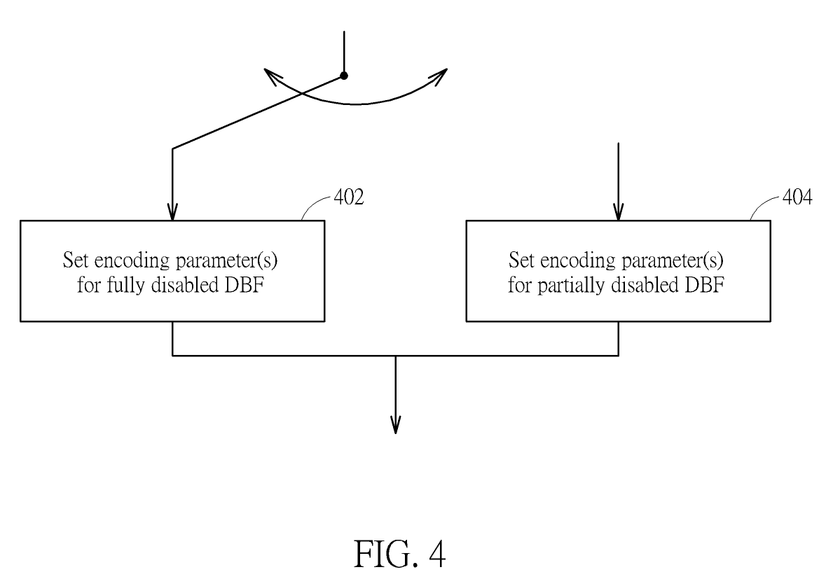

In this embodiment, the video encoder 102 may employ independent partition coding to allow each frame partition to be independently encoded at the video encoder 102 and independently decoded at the video decoder 104. FIG. 4 is a diagram illustrating an independent partition coding design according to an embodiment of the present invention. When the video encoder 102 shown in FIG. 1 is implemented using the video encoder 200 shown in FIG. 2, the control circuit 202 divides the frame IMG into partitions (such as slices or tiles) and divides each of the partitions into coding blocks, where each of the coding blocks is composed of pixels. In addition, one coding block may be further divided into one or more prediction blocks, and may be further divided into one or more transform blocks.

To prevent the parallel processing performance of adjacent partitions from being degraded by data dependency of the deblocking filtering, the control circuit 202 may perform step 402 to set encoding parameter(s) for configuring a deblocking filter (e.g., in-loop filter 218) into a fully disabled deblocking filter (DBF) or may perform step 404 to set encoding parameter(s) for configuring the deblocking filter into a partially disabled deblocking filter, where the encoding parameter(s) may be control syntax elements that are sent to the entropy encoding circuit 214 such that the encoding parameter(s) are embedded in the bitstream BS. The embedded encoding parameter(s) for configuring the deblocking filter is used by the video decoder 104 (which may be implemented using the video decoder 300 shown in FIG. 3) to appropriately operate the deblocking filter (e.g., in-loop filter 318) in a fully disabled deblocking filter or a partially disabled deblocking filter.

In a case where the video encoder 200 is an H.264 encoder, each partition is a slice, and the control syntax elements used for configuring the deblocking filter to be a fully disabled deblocking filter or a partially disabled deblocking filter may include deblocking_filter_control_present_flag in the picture parameter set (PPS) and/or disable_deblocking_filter_idc in the slice header.

In another case where the video encoder 200 is an H.265 encoder, each partition is a slice or a tile, and the control syntax elements used for configuring the deblocking filter to be a fully disabled deblocking filter or a partially disabled deblocking filter may include at least one of tiles_enabled_flag, loop_filter_across_tiles_enabled_flag, pps_loop_filter_across_slices_enabled_flag, deblocking_filter_control_present_flag, deblocking_filter_override_enabled_flag, pps_deblocking_filter_disabled_flag in the picture parameter set (PPS) and/or at least one of deblocking_override_flag, slice_deblocking_filter_disabled_flag and slice_loo_filter_across_slices_enabled_flag in the slice segment header.

In yet another case where the video encoder 200 is a VP9 encoder, each partition is a tile, and the control syntax elements used for configuring the deblocking filter to be a fully disabled deblocking filter or a partially disabled deblocking filter may include filter_level in the uncompressed header and/or an enabled segmentation feature.

When the deblocking filter (e.g., in-loop filter 218/318) is configured to be a fully disabled deblocking filter according to a selected independent partition coding strategy, the deblocking filtering process is disabled for all partitions/blocks/coding blocks (i.e., the entire frame). In this way, deblocking filtering's data dependency between adjacent partitions no longer exists, thus improving the parallel encoding performance of the video encoder as well as the parallel decoding performance of the video decoder. Concerning the video encoder 200 being an H.264 encoder, one frame is divided into slices, and one possible setting of control syntax elements may be deblocking_filter_control_present_flag=1 in PPS and disable_deblocking_filter_idc=1 in slice header. With disable_deblocking_filter_idc=1, the deblocking filter is not applied to the entire current slice. Concerning the video encoder 200 being an H.265 encoder, one frame is divided into slices or tiles, and a first possible setting of control syntax elements may be deblocking_filter_control_present_flag=1, deblocking_filter_override_enabled_flag=0, and pps_deblocking_filter_disabled_flag=1 in PPS. Alternatively, a second possible setting of control syntax elements may be deblocking_filter_control_present_flag=1 and deblocking_filter_override_enabled_flag=1 in PPS, and deblocking_filter_override_flag=1 and slice_deblocking_filter_disabled_flag=1 in slice segment header. Concerning the video encoder 200 being a VP9 encoder, one frame may be divided into vertical tiles arranged horizontally, and one possible setting of control syntax elements may be filter_level=0 in uncompressed header. With filter_level=0, the deblocking filter is not applied to the entire current frame.

Since control syntax elements are embedded in the bitstream BS, the video decoder 104 (which may be implemented using the video decoder 300) can derive the signaled control syntax elements at the entropy decoding circuit 302, such that the deblocking filter at the video decoder 104 can be configured to be a fully disabled deblocking filter.

However, a reconstructed frame may suffer from blocking artifacts when the deblocking filtering process of the entire frame is disabled due to the fully disabled deblocking filter. Another independent partition coding strategy is to configure the deblocking filter to be a partially disabled deblocking filter which disables the deblocking filtering process at partition boundaries (e.g., slice boundaries or tile boundaries) only. For example, one partition (e.g., slice or tile) may include first coding blocks located at partition boundaries each between two adjacent partitions within a frame, and may further include second coding blocks not located at the partition boundaries each between two adjacent partitions within the same frame. Compared to the fully disabled deblocking filter, the partially disabled deblocking filter can reduce blocking artifacts resulting from block-based encoding performed upon the second coding blocks that are not located at the partition boundaries.

When the deblocking filter (e.g., in-loop filter 218/318) is configured to be a partially disabled deblocking filter according to a selected independent partition coding strategy, the deblocking filtering process is disabled at the partition boundaries only. Similarly, deblocking filtering's data dependency between adjacent partitions no longer exists, thus improving the parallel encoding performance of the video encoder as well as the parallel decoding performance of the video decoder.

Concerning the video encoder 200 being an H.264 encoder, one frame is divided into slices, and one possible setting of control syntax elements may be deblocking_filter_control_present_flag=1 in PPS and disable_deblocking_filter_idc=2 in slice header. With disable_deblocking_filter_idc=2, the deblocking filter is not applied to the slice boundary. Concerning the video encoder 200 being an H.265 encoder, one frame is divided into slices or tiles. When partitions are tiles, one possible setting of control syntax elements for disabling the deblocking filtering at tile boundary may be tiles_enabled_flag=1 and loop_filter_across_tiles_enabled_flag=0 in PPS. When partitions are slices, a first possible setting of control syntax elements for disabling the deblocking filtering at slice boundary may be pps_loop_filter_across_slices_enabled_flag=1 and deblocking_filter_control_present_flag=1 in PPS. Alternatively, a second possible setting of control syntax elements for disabling the deblocking filtering at slice boundary may be pps_filter_across_slices_enabled_flag=1, deblocking_filter_control_present_flag=1, and deblocking_filter_override_enabled_flag=1 in PPS, and deblocking_filter_override_flag=1, slice_deblocking_filter_disabled_flag=0, and slice_loop_filter_across_slices_enabled_flag=1 in slice segment header.

Since control syntax elements are embedded in the bitstream BS, the video decoder 104 (which may be implemented using the video decoder 300) can derive the signaled control syntax elements at the entropy decoding circuit 302, such that the deblocking filter at the video decoder 104 can be configured to be a partially disabled deblocking filter.

Concerning the video encoder 200 being a VP9 encoder, one frame may be divided into vertical tiles arranged horizontally, and the deblocking filter is used to avoid blocking artifacts along the transform block edges. However, solely using the aforementioned control syntax element filter_level is unable to achieve the objective of configuring a deblocking filter to be a partially enabled deblocking filter that does not apply deblocking filtering at the tile boundary only. The present invention therefore proposes using the control syntax element filter_level in conjunction with a segmentation feature supported by the VP9 coding standard to achieve the objective of configuring a deblocking filter to be a partially enabled deblocking filter.

In this embodiment, the control circuit 202 divides the frame IMG into vertical tiles arranged horizontally, wherein each of the vertical tiles is one partition of the frame IMG. In accordance with the proposed independent partition coding strategy that configures a deblocking filter to be a partially disabled deblocking filter, the vertical tiles can be encoded/decoded independently. VP9 provides a means of segmenting the frame and then applying various signals or adjustments at the segment level. Hence, the control circuit 202 assigns a first segmentation identifier (e.g., segment_id=0) to each of first coding blocks located at partition boundaries (e.g., tile boundaries for VP9) each between two adjacent partitions (e.g., adjacent tiles for VP9) within the frame, wherein the first coding blocks belong to a first segment (e.g., segment #0), and the first segmentation identifier (e.g., segment_id=0) is signaled via the output bitstream BS per first coding block. In addition, the control circuit 202 assigns a second segmentation identifier (e.g., segment_id=1) to each of second coding blocks not located at the partition boundaries (e.g., tile boundaries for VP9) each between two adjacent partitions (e.g., adjacent tiles for VP9) within the frame, wherein the second coding blocks belong to a second segment (e.g., segment #1), and the second segmentation identifier (e.g., segment_id=1) is signaled via the output bitstream BS per second coding block. In other words, the control circuit 202 categorizes coding blocks at the tile boundaries into the first segment (e.g., segment #0), and categorizes coding blocks not at the tile boundaries into the second segment (e.g., segment #1). To put it another way, one frame is segmented into the first segment (e.g., segment #0) and the second segment (e.g., segment #1).

It should be noted that one segmentation identifier has only one filter level. In other words, coding blocks belonging to a segment have the same filter level. In addition, transform blocks within a coding block share the same segmentation identifier. With regard to the first segment (e.g., segment #0), the control circuit 202 sets the control syntax element filter_level by 0 (i.e., filter_level=0), such that all transform block edges within each first coding block categorized into the first segment are not deblocking filtered by the deblocking filter. In other words, the in-loop filter 218 (e.g., deblocking filter) is configured by a predetermined in-loop filtering setting (e.g., filter_level=0) in response to the first segmentation identifier (e.g., segment_id=0), wherein the in-loop filter 218 (e.g., deblocking filter) with the predetermined in-loop filtering setting (e.g., filter_level=0) does not apply in-loop filtering (e.g., deblocking filtering) to each reconstructed coding block corresponding to the first segment.

With regard to the second segment (e.g., segment #1), the control circuit 202 sets the control syntax element filter_level by an appropriate value (e.g., filter_level>0), such that all transform block edges within each second coding block categorized into the second segment are allowed to be deblocking filtered by the deblocking filter (e.g., in-loop filter 218). In other words, the deblocking filter (e.g., in-loop filter 218) is allowed to apply the in-loop filtering to each reconstructed coding block corresponding to the second segment. With setting of the control syntax element filter_level and enabling of the segmentation feature, the deblocking filter (e.g., in-loop filter 218) of a VP9 encoder can be configured to be a partially disabled deblocking filter as needed.

Since the control syntax element per segment and the segmentation identifier per coding block are embedded in the bitstream BS, the video decoder 104 (which may be implemented using the video decoder 300) can derive the signaled control syntax element and the signaled segmentation identifier at the entropy decoding circuit 302, such that the deblocking filter of the video decoder 104 can be configured to be a partially disabled deblocking filter. For example, when a parsed segmentation identifier of a coding block is a first segmentation identifier (e.g., segment_id=0), the in-loop filter 318 (e.g., deblocking filter) is arranged to employ a signaled first in-loop filtering setting (e.g., filter_level=0 for segment #0) in response to the first segmentation identifier (e.g., segment_id=0), wherein the in-loop filter 318 (e.g., deblocking filter) with the signaled first in-loop filtering setting (e.g., filter_level=0 for segment #0) does not apply in-loop filtering (e.g., deblocking filtering) to the reconstructed coding block belonging to the first segment (e.g., segment #0). For another example, when the parsed segmentation identifier of a coding block is a second segmentation identifier (e.g., segment_id=1), the in-loop filter 318 (e.g., deblocking filter) is arranged to employ a signaled second in-loop filtering setting (e.g., filter_level>0 for segment #1) in response to the second segmentation identifier (e.g., segment_id=1), wherein the in-loop filter 318 (e.g., deblocking filter) with the signaled second in-loop filtering setting (e.g., filter_level>0 for segment #1) is allowed to apply in-loop filtering (e.g., deblocking filtering) to the reconstructed coding block belonging to the second segment (e.g., segment #1).

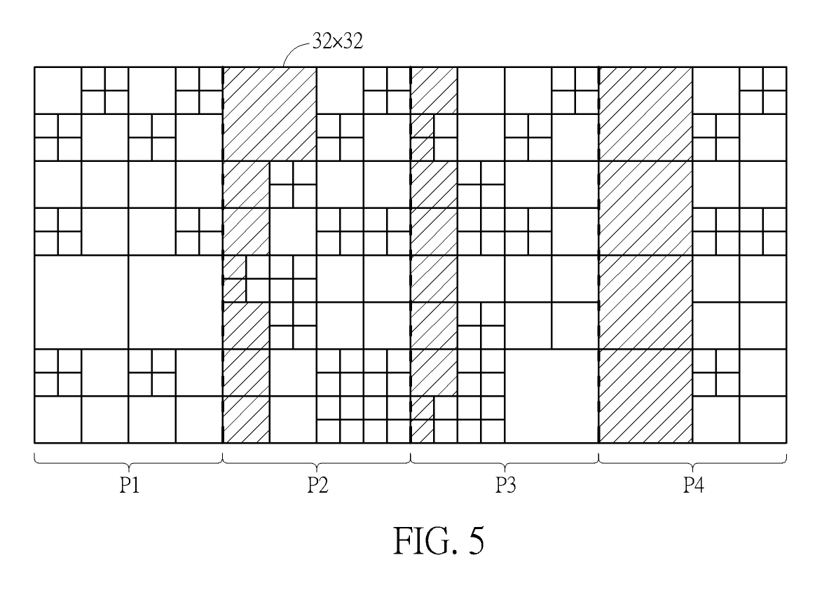

FIG. 5 is a diagram illustrating a result of segmenting a frame into a first segment and a second segment under an unconstrained mode decision according to an embodiment of the present invention. When the video encoder is a VP9 encoder, the control circuit 202 may divide one frame into vertical tiles arranged horizontally for independent encoding/decoding. In this embodiment, the frame is divided into four vertical tiles, P1, P2, P3 and P4, which are arranged horizontally. The control circuit 202 further divides each of the vertical tiles P1-P4 into coding blocks. Since the unconstrained mode decision is employed, the control circuit 202 determines a coding block size of each first coding block at a tile boundary between two adjacent tiles by an optimal coding block size selected from candidate coding block sizes (e.g., 64×64, 64×32, 32×64, 32×32, 32×16, 16×32, 16×16, . . . 8×8, etc.), and determines a coding block size of each second coding block not at a tile boundary between two adjacent tiles by an optimal coding block size selected from candidate coding block sizes (e.g., 64×64, 64×32, 32×64, 32×32, 32×16, 16×32, 16×16, . . . 8×8, etc.). For example, among the candidate coding block sizes, the optimal coding block size makes a coding block have smallest distortion resulting from the block-based encoding. As shown in FIG. 5, the first segment (which is represented by a shaded area) may have 32×32 coding blocks, 16×16 coding blocks and 8×8 coding blocks, and the second segment (which is represented by an unshaded area) may have 32×32 coding blocks, 16×16 coding blocks and 8×8 coding blocks. As mentioned above, no deblocking filtering is applied to first coding blocks belonging to the first segment. Since the mode decision for determining a coding block size is not constrained, it is possible that a coding block size of a first coding block at a tile boundary between two adjacent tiles is large (e.g., 32×32). As a result, the blocking artifacts may be severe in a reconstructed frame due to the fact that the first segment has a large non-deblocking-filtered area.

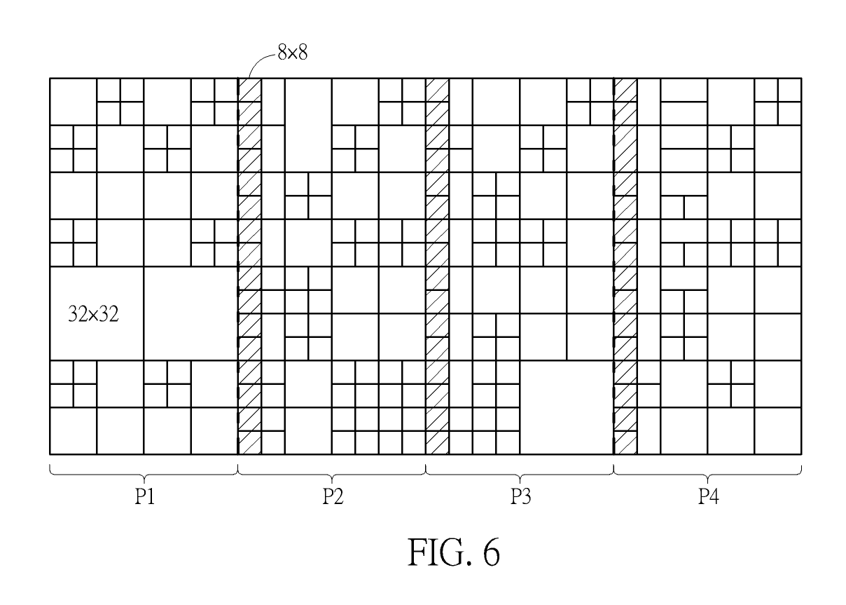

To reduce the non-deblocking-filtered area (i.e., an area of the first segment), the present invention proposes using a constrained mode decision. FIG. 6 is a diagram illustrating a result of segmenting a frame into a first segment and a second segment under a constrained mode decision according to an embodiment of the present invention. When the video encoder is a VP9 encoder, the control circuit 202 may divide one frame into vertical tiles arranged horizontally for independent encoding/decoding. In this embodiment, the frame is divided into four vertical tiles, P1, P2, P3 and P4, which are arranged horizontally. The control circuit 202 further divides each of the vertical tiles P1-P4 into coding blocks. In this embodiment, the control circuit 202 conditionally selects an optimal coding block size for a coding block. For example, the control circuit 202 determines a coding block size of each first coding block at a tile boundary between two adjacent tiles by a minimum coding block size (e.g., 8×8) selected from candidate coding block sizes (e.g., 64×64, 64×32, 32×64, 32×32, 32×16, 16×32, 16×16, . . . 8×8, etc.), and determines a coding block size of each second coding block not at a tile boundary between two adjacent tiles by an optimal coding block size selected from candidate coding block sizes (e.g., 64×64, 64×32, 32×64, 32×32, 32×16, 16×32, 16×16, etc.). As shown in FIG. 6, the first segment (which is represented by a shaded area) has 8×8 coding blocks (i.e., coding blocks with the same minimum coding block size 8×8) only, while the second segment (which is represented by an unshaded area) may have 32×32 coding blocks, 16×16 coding blocks and 8×8 coding blocks. As mentioned above, no deblocking filtering is applied to first coding blocks belonging to the first segment. Since the mode decision for determining a coding block size is restricted for coding blocks at tile boundaries each between two adjacent tiles, the first segment is composed of small-sized coding blocks only, thus having a small non-deblocking-filtered area. In this way, the blocking artifacts can be reduced in a reconstructed frame due to the fact that the first segment is constrained to have a small non-deblocking-filtered area.

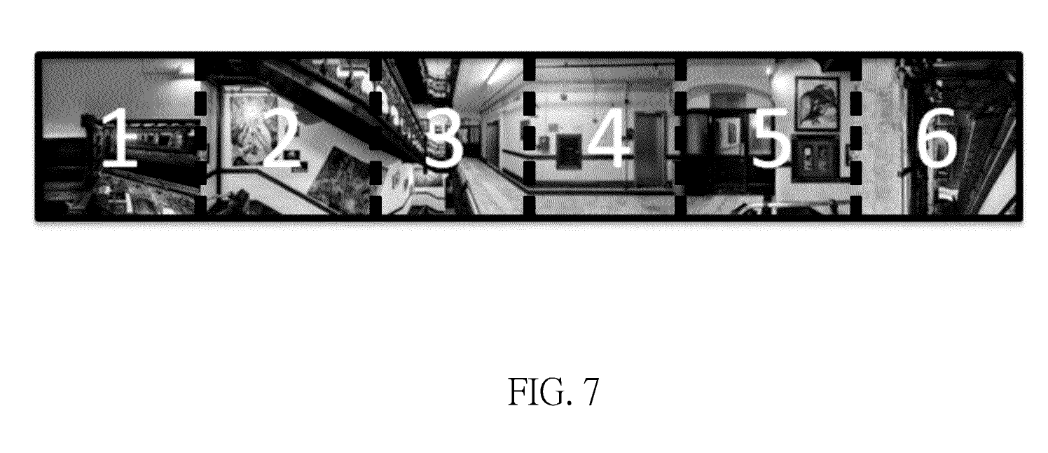

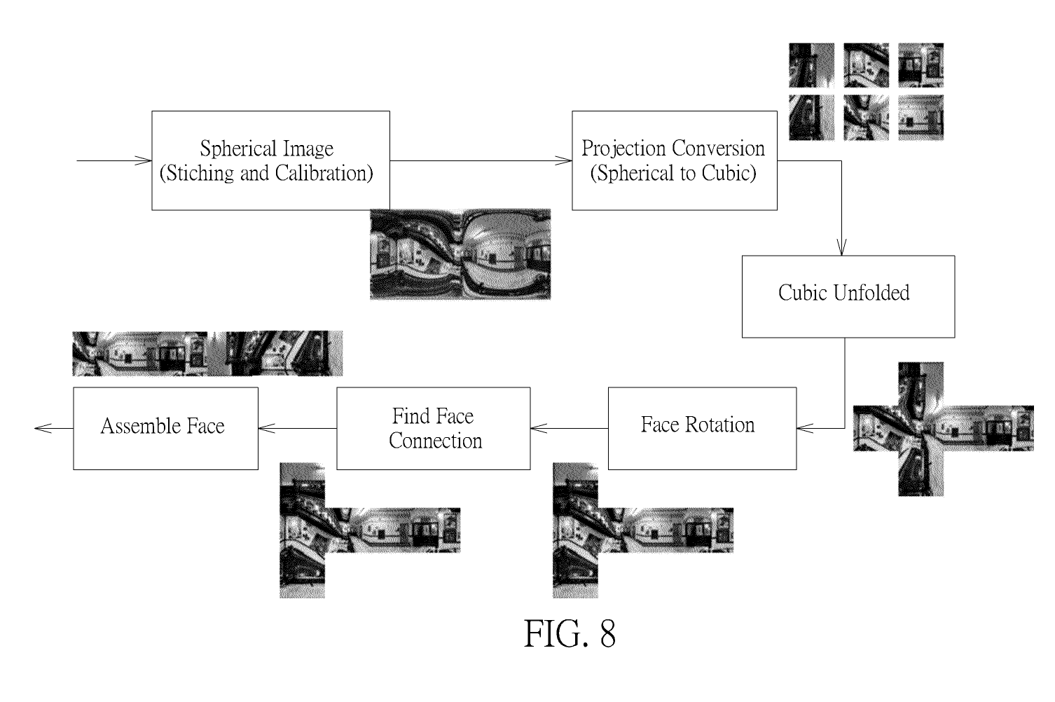

The video encoder 102 using independent partition coding can remove in-loop filtering's data dependency between adjacent partitions, thus facilitating parallel/independent encoding of multiple partitions at the video encoder 102 and parallel/independent decoding of multiple partitions at the video decoder 104. Some applications may benefit from the parallel/independent decoding of multiple partitions at the video decoder 104. For example, with the help of independent partition coding at the video encoder 102 (e.g., VR9 encoder), the video decoder 104 (e.g., VR9 decoder) may support a 360-degree virtual reality (360VR) region decode function. FIG. 7 is a diagram illustrating a frame that has a 360VR assembled cubic format and is composed of independently decodable partitions according to an embodiment of the present invention. In accordance with the 360VR assembled cubic format, there are six cubic faces indicated by symbols “1”, “2”, “3”, “4”, “5”, “6” shown in FIG. 7, where the six cubic faces are assembled in a row to form one frame to be encoded. FIG. 8 is a diagram illustrating a cubic assembler design according to an embodiment of the present invention. A spherical image is created by stitching and calibration, and is converted into six cubic faces through projection conversion (i.e., spherical-to-cubic conversion). After processed by cubic unfolding, face rotation, face connection finding and face assembling, the six cubic faces are arranged to form the frame as illustrated in FIG. 7. As shown in FIG. 7, the six cubic faces are arranged horizontally, where one cubic face serves as one vertical tile that can be independently decoded at the video decoder 104 when independent partition coding is employed by the video encoder 102. The frame composed of six cubic faces is divided into 6 vertical tiles arranged horizontally, where the tile boundaries comprise cubic face boundaries each between two adjacent cubic faces arranged in the frame. In this embodiment, all of the tile boundaries in the same frame may be cubic face boundaries. Alternatively, only a portion of the tile boundaries in the same frame may be cubic face boundaries. In an exemplary design, one of the constrained mode decision based segmentation technique and the unconstrained mode decision based segmentation technique may be employed to decide coding blocks within each vertical tile and then categorize coding blocks at tile boundaries into a first segment and categorize coding blocks not at tile boundaries into a second segment. Hence, the video decoder 104 (which may be implemented using the video decoder 300) has the deblocking filter (e.g., in-loop filter 318) configured to be a partially disabled deblocking filter, thereby supporting the parallel/independent decoding of multiple vertical tiles of a 360VR frame.

When used by the 360VR application, the video decoder 104 (which may be implemented using the video decoder 300) receives viewport information that indicates a viewport area (i.e., user's visible area), and then selectively and independently decodes the corresponding vertical tiles of the 360VR frame that compass the viewport area. For example, when the viewport area covers the 1^{st}, 2^{nd} and 4^{th} cubic faces, the video decoder 104 only needs to decode the 1^{st}, 2^{nd} and 4^{th} cubic faces for display due to the fact that the 1^{st}, 2^{nd} and 4^{th} cubic faces can be independently decoded. Taking deblocking filtering of the 4^{th} cubic face for example, there is no data dependency between the 4^{th} cubic face and the 3^{rd} cubic face. Hence, decoding of the 3^{rd} cubic face is not needed for obtaining display data of the viewport area currently indicated by the viewport information.

In above example, the video encoder 102 (e.g., VR9 encoder) using independent partition coding processes the frame IMG with the 360VR assembled cubic format, where one cubic face serves as one vertical tile that is independently decodable; and the video decoder 104 selectively and independently decodes the viewport area according to the viewport information. However, this is for illustrative purposes only, and is not meant to be a limitation of the present invention. Alternatively, the video encoder 102 (e.g., VR9 encoder) using independent partition coding may be employed to process the frame IMG with a different 360VR format (e.g., the spherical image shown in FIG. 8), where the spherical image is divided into a plurality of independently decodable tiles; and the video decoder 104 selectively and independently decode the corresponding tiles that compass the viewport area according to the viewport information. This also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of encoding a frame to generate an output bitstream, comprising:
dividing the frame into partitions;
dividing each of the partitions into blocks, wherein each of the blocks is composed of pixels;
assigning a first segmentation identifier to each of first blocks located at partition boundaries each between two adjacent partitions within the frame, wherein the first blocks belong to a first segment, and the first segmentation identifier is signaled via the output bitstream per first block; and
encoding each of the blocks, comprising:
generating reconstructed blocks for the blocks, respectively; and
configuring an in-loop filter by a predetermined in-loop filtering setting in response to the first segmentation identifier, wherein the in-loop filter with the predetermined in-loop filtering setting does not apply in-loop filtering to each reconstructed block corresponding to the first segment.

2. The method of claim 1, further comprising:
assigning a second segmentation identifier to each of second blocks not located at the partition boundaries each between two adjacent partitions within the frame, wherein the second blocks belong to a second segment, and the second segmentation identifier is signaled via the output bitstream per second block;
wherein encoding each of the blocks further comprises:
applying the in-loop filtering to each reconstructed block corresponding to the second segment.

3. The method of claim 1, wherein dividing each of the partitions into the blocks comprises:
regarding each of the first blocks, determining a block size of the first block by an optimal block size selected from candidate block sizes.

4. The method of claim 1, wherein dividing each of the partitions into the blocks comprises:
regarding each of the first blocks, determining a block size of the first block by a minimum block size specified by a video coding standard.

5. The method of claim 1, wherein dividing each of the partitions into the blocks comprises:
setting block sizes of the first blocks by a same block size.

6. The method of claim 1, wherein the in-loop filter is a deblocking filter, a sample adaptive offset (SAO) filter, an adaptive loop filter (ALF), a dering filter, or a constrained low-pass filter (CLPF).

7. The method of claim 1, wherein the partitions comprise vertical tiles horizontally arranged within the frame only.

8. The method of claim 1, wherein the frame has a 360-degree virtual reality (360VR) format.

9. The method of claim 8, wherein the 360VR format is an assembled cubic format, and the frame is composed of six cubic faces arranged horizontally.

10. The method of claim 9, wherein the partition boundaries comprise cubic face boundaries each between two adjacent cubic faces.

11. A method of decoding an input bitstream generated from encoding a frame that is divided into partitions, each of the partitions being divided into blocks, each of the blocks being composed of pixels, the method comprising:
decoding each of blocks within a selected partition of the frame, comprising:
generating a reconstructed block for the block;
deriving a segmentation identifier of the block from the input bitstream; and
when the segmentation identifier is a first segmentation identifier, configuring an in-loop filter by a predetermined in-loop filtering setting in response to the first segmentation identifier, wherein the in-loop filter with the predetermined in-loop filtering setting does not apply in-loop filtering to the reconstructed block belonging to a first segment, and the first segment comprises first blocks located at partition boundaries each between two adjacent partitions within the frame.

12. The method of claim 11, wherein decoding each of the blocks within the selected partition of the frame further comprises:
when the segmentation identifier is a second segmentation identifier, applying the in-loop filtering to the reconstructed block belonging to a second segment, wherein the second segment comprises second blocks not located at the partition boundaries each between two adjacent partitions within the frame.

13. The method of claim 11, wherein the in-loop filter is a deblocking filter, a sample adaptive offset (SAO) filter, an adaptive loop filter (ALF), a dering filter, or a constrained low-pass filter (CLPF).

14. The method of claim 11, wherein the partitions comprise vertical tiles horizontally arranged within the frame only.

15. The method of claim 11, further comprising:
receiving viewport information indicative of a viewport area; and
referring to the viewport information to select at least one partition that compasses the viewport area for decoding, wherein the at least one partition is only a portion of the partitions, and comprises the selected partition.

16. The method of claim 15, wherein the frame has a 360-degree virtual reality (360VR) format.

17. The method of claim 16, wherein the 360VR format is an assembled cubic format, and the frame is composed of six cubic faces arranged horizontally.

18. The method of claim 17, wherein the partition boundaries comprise cubic face boundaries each between two adjacent cubic faces.

19. A video encoder for encoding a frame to generate an output bitstream, comprising:
a control circuit, arranged to divide the frame into partitions, divide each of the partitions into blocks each being composed of pixels, and assign a first segmentation identifier to each of first blocks located at partition boundaries each between two adjacent partitions within the frame, wherein the first blocks belong to a first segment, and the first segmentation identifier is signaled via the output bitstream per first block; and
an encoding circuit, arranged to encode each of the blocks, wherein the encoding circuit comprises:
a reconstruction circuit, arranged to generate reconstructed blocks for the blocks, respectively; and
an in-loop filter, arranged to employ a predetermined in-loop filtering setting in response to the first segmentation identifier, wherein the in-loop filter with the predetermined in-loop filtering setting does not apply in-loop filtering to each reconstructed block corresponding to the first segment.

20. A video decoder for decoding an input bitstream generated from encoding a frame that is divided into partitions, each of the partitions being divided into blocks, each of the blocks being composed of pixels, the video decoder comprising:
a decoding circuit, arranged to decode each of blocks within a selected partition of the frame, wherein the decoding circuit comprises:
a reconstruction circuit, arranged to generate a reconstructed block for the block;
an entropy decoding circuit, arranged to derive a segmentation identifier of the block from the input bitstream; and
an in-loop filter, wherein when the segmentation identifier is a first segmentation identifier, the in-loop filter is arranged to employ a predetermined in-loop filtering setting in response to the first segmentation identifier, wherein the in-loop filter with the predetermined in-loop filtering setting does not apply in-loop filtering to the reconstructed block belonging to a first segment, and the first segment comprises first blocks located at partition boundaries each between two adjacent partitions within the frame.

21. An in-loop filtering method for a frame that is divided into partitions, each of the partitions being divided into blocks, each of the blocks being composed of pixels, the in-loop filtering method comprising:
receiving a reconstructed block; and
when the reconstructed block is any of first blocks located at partition boundaries each between two adjacent partitions within the frame, blocking an in-loop filter from applying in-loop filtering to the reconstructed block;
wherein the frame has a 360-degree virtual reality (360VR) assembled cubic format and is composed of six cubic faces arranged horizontally, and the partition boundaries comprise cubic face boundaries each between two adjacent cubic faces.
